(19) United States
(12) Patent Application Publication
(10) Pub. No.: US 2023/0061911 A1
(43) Pub. Date: Mar. 2, 2023

(54) SYSTEM, METHOD AND COMPUTER PROGRAM FOR FORECASTING A TREND OF A NUMERICAL VALUE OVER A TIME INTERVAL

(71) Applicant: Sony Group Corporation, Tokyo (JP)

(72) Inventors: Olivier ELSHOCHT, Stuttgart (DE); Orlando ANUNCIAÇÃO, Stuttgart (DE); Tri Vu KHAC, Stuttgart (DE)

(73) Assignee: Sony Group Corporation, Tokyo (JP)

(21) Appl. No.: 17/798,319

(22) PCT Filed: Mar. 4, 2021
(86) PCT No.: PCT/EP2021/055451

§ 371 Date: Aug. 9, 2022

(30) Foreign Application Priority Data
Mar. 6, 2020 (EP) 20161538.2

(51) Int. Cl. G06Q 30/02; G06Q 10/04

(52) U.S. Cl. CPC G06Q 30/0202; G06Q 10/04

(57) ABSTRACT

Examples relate to a system, to a method and to a computer program for forecasting a trend of a numerical value over a time interval. The system comprises processing circuitry configured to determine an estimate of the numerical value for the time interval by training a first machine-learning model based on historical data on the numerical value. The processing circuitry is configured to divide the time interval into a first and a second sub-interval. The processing circuitry is configured to determine an estimate of the numerical value for the first sub-interval by training a second machine-learning model based on the historical data on the numerical value. The processing circuitry is configured to determine an estimate of the numerical value for the second sub-interval based on the estimate of the numerical value for the time interval and based on the estimate of the numerical value for the first sub-interval.

### FIELD

Examples relate to a system, to a method and to a computer program for forecasting a trend of a numerical value over a time interval.

### BACKGROUND

The forecasting of trends is used in a variety of applications. For example, in business sce-narios, product demand or market trends may be forecast. For example, businesses may forecast product demand in order to optimize their supply chain. In logistics, forecasting may be used to predict a utilization of vehicles or road. Within vehicles, forecasting may be used to determine a suitable time for re-fueling (or rather charging) a vehicle, taking into account a development of traffic jams on the road. In machines, forecasting is used to schedule maintenance.

### SUMMARY

There may be a desire for providing an improved concept for forecasting a trend of a numerical value.

This desire is addressed by the subject-matter of the independent claims.

Embodiments of the present disclosure are based on the finding that forecasting that starts with an entire time interval being forecast as a whole, and repeating the forecast for smaller and smaller time intervals until a desired time-granularity is reached, providing a concept for forecasting a trend of a numerical value which enables a quick evaluation of a quality of the forecast, while avoiding the accumulation of forecasting errors over a longer period of time. On the one hand, as the forecast is provided for the entire time interval as a start, a quick evaluation can be performed on the quality of the forecast (e.g. by the user), and the forecasting can be cancelled and repeated with other parameters or another machine-learning algorithm without having to complete the forecasting down to the desired time-granularity, reducing a turnover time during the setup of the forecast. On the other hand, the forecasts for the smaller and smaller time intervals may use the forecasting result for the longer time intervals. This may save time and may yield more precise results, as forecasts for longer time intervals are often more precise than individual forecasts over shorter time intervals.

Embodiments of the present disclosure provide a system for forecasting a trend of a numerical value over a time interval. The system comprises processing circuitry configured to determine an estimate of the numerical value for the time interval by training a first machine-learning model based on historical data on the numerical value. The processing circuitry is configured to divide the time interval into a first and a second sub-interval. The processing circuitry is configured to determine an estimate of the numerical value for the first sub-interval by training a second machine-learning model based on the historical data on the numerical value. The processing circuitry is configured to determine an estimate of the numerical value for the second sub-interval based on the estimate of the numerical value for the time interval and based on the estimate of the numerical value for the first sub-interval. By estimating the numerical value for the time interval, a quick estimate of the aggregate over the entire time interval may be obtained, which may enable the user to make a quick evaluation of the used algorithm and parameters. By determining the estimate for the second sub-interval based on the estimate for the time interval and the estimate for the first sub-interval, both a computational effort may be reduced, and an overall precision of the estimate may be increased.

For example, the processing circuitry may be configured to determine the estimate of the numerical value for the second sub-interval by subtracting the estimate of the numerical value for the first sub-interval from the estimate of the numerical value for the time interval. As the estimate for the second sub-interval is based on the estimate for the entire time interval, an accumulation of estimation errors may be avoided.

In various embodiments, the recursive approach may be repeated to yield estimates for even shorter sub-intervals. For example, the processing circuitry may be configured to determine estimates of the numerical value for sub-intervals of the first or second sub-interval by dividing the respective sub-interval into two further sub-intervals, determining the estimate of the numerical value for a first of the further sub-intervals by training a machine-learning model based on the historical data, and determining the estimate of the numerical value of a second of the further sub-intervals based on the estimate of the numerical value for the first further sub-interval and based on the estimate of the numerical value for the respective sub-interval being divided into the two further sub-intervals. Thus, the estimates may be refined in subsequent processing iterations, giving the user the option of cancelling the forecasting at any time to try another algorithm or parameter.

In various embodiments, the estimate of the numerical value for the respective second sub-interval may be determined without training a machine-learning model. This may both save time and help avoid an accumulation of estimation errors.

In general, the machine-learning models may be trained based on a machine-learning configuration. The machine-learning configuration may specify a machine-learning algorithm and one or more parameters of the machine-learning algorithm. The processing circuitry may be configured to adapt the machine-learning configuration based on an evaluation of at least one of the estimates. At least one of the estimates, preferably the estimate determined for the entire time interval, may be used to quickly evaluate the performance of the machine-learning-based estimation, to enable a rapid adaptation of the algorithm or parameters.

For example, the processing circuitry may be configured to adapt the machine-learning configuration based on a user evaluation of at least one of the estimates. In other words, the user may evaluate the estimate or estimates, and adjust the machine-learning configuration if the estimate or estimates indicate room for improvement.

In other words, the processing circuitry may be configured to evaluate at least one of the estimates by providing information on at least one of the estimates to a user via a user interface, and by obtaining information on the evaluation of the at least one estimate from the user via the user interface. The user may use the user interface to control the determination of the estimates, and the machine-learning configuration associated with it.

The system may be configured to abort the determination of the estimates that is based on the initially used machine-learning configuration after adapting the machine-learning configuration, and to repeat the determination of the estimates using the adapted machine-learning configuration. Thus, a fast turnaround can be achieved.

In various embodiments, the respective machine-learning model is trained by determining a first subset of the historical data and a second subset of the historical data. The second subset of the historical data may represent a length of time that is equal to the time interval the respective machine-learning model is being trained for. The respective machine-learning model may be trained by using the first subset of the historical data as training input and the second subset as training output for the training of the respective machine-learning model. For example, the subsets may be chosen such that the relation between training input and training output matches the relation between the historical data being used to determine the respective estimate and the time interval that the estimated is being determined for. Thus, the trained machine-learning model may be used to determine an estimate for a time interval or sub-interval that has a matching relationship to the historical data being used as input data to the machine-learning model.

For example, the second sub-interval may chronologically follow the first sub-interval. If the first sub-interval is at an earlier time relative to the historical data, the estimates may be more precise.

In some embodiments, the first and second sub-interval are of equal length. Alternatively, the first and second sub-interval are of different length. When using sub-intervals of equal length, an automated determination of the sub-intervals may be facilitated, while different lengths may be used in cases where the desired length of the sub-intervals is not obtainable otherwise, e.g. when sub-dividing a quarter of a year in months, with one of the sub-intervals covering one month and the other covering two.

In general, the system may be used to provide a user with a quick way to evaluate multiple machine-learning configurations. Thus, the estimates may be provided to the user, so the user can perform the evaluation. Accordingly, the processing circuitry may be configured to provide information on at least one of the estimates to a user via a user interface.

For example, the system may comprise a display. The processing circuitry may be configured to provide the information on the at least one estimate via a user interface being shown on the display. For example, this may be the case if the system is implemented by a workstation computer or a laptop computer.

Alternatively or additionally, the processing circuitry may be configured to provide the information on the at least one estimate to a remote user interface via a computer network. For example, the determination of the estimates may be performed in by a backend computer, e.g. in a computer or virtual machine in a datacenter or cloud computing environment.

In some embodiments, the processing circuitry is configured to provide the estimate of the numerical value for the time interval to the user before starting or before completing the determination of the estimate of the numerical value for the first sub-interval. In more general terms, the estimate of the numerical value for a time interval or sub-interval may be provided before the determination of the estimates of the numerical value for sub-intervals of the time interval or of the sub-interval is completed. Thus, the user does not have to wait for all of the estimates to be completed, which may enable a shorter turnover time.

In addition (or alternatively) to the provision of the estimates to the user, the user interface may also be used to control the system, e.g. to input parameters to be used for the estimation. For example, the processing circuitry may be configured to obtain at least one of information on the time interval, information on the first and second sub-interval, and information on a machine-learning configuration from a user via a user interface.

In various embodiments, the numerical value relates to a demand for a product. The historical data may relate to historical demand for the product. Thus, embodiments of the present disclosure may be used for product demand forecasts.

Embodiments of the present disclosure further provide a method for estimating a trend of a numerical value over a time interval. The method comprises determining an estimate of the numerical value for the time interval by training a first machine-learning model based on historical data on the numerical value. The method comprises dividing the time interval into a first and a second sub-interval. The method comprises determining an estimate of the numerical value for the first sub-interval by training a second machine-learning model based on the historical data on the numerical value. The method comprises determining an estimate of the numerical value for the second sub-interval based on the estimate of the numerical value for the time interval and based on the estimate of the numerical value for the first sub-interval.

Embodiments of the present disclosure further provide a computer program having a program code for performing the above method, when the computer program is executed on a computer, a processor, or a programmable hardware component.

### BRIEF DESCRIPTION OF THE FIGURES

Some examples of apparatuses and/or methods will be described in the following by way of example only, and with reference to the accompanying figures, in which

FIGS. 1a to 1c show block diagrams of embodiments of a system for forecasting a trend of a numerical value over a time interval;

FIG. 2 shows a flow chart of a method for forecasting a trend of a numerical value over a time interval;

FIG. 3a shows a schematic diagram of two approaches for forecasting a trend of a numerical value; and

FIG. 3b shows schematic diagrams of exemplary forecasts.

### DETAILED DESCRIPTION

Various examples will now be described more fully with reference to the accompanying drawings in which some examples are illustrated. In the figures, the thicknesses of lines, layers and/or regions may be exaggerated for clarity.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Same or like numbers refer to like or similar elements throughout the description of the figures, which may be implemented iden-tically or in modified form when compared to one another while providing for the same or a similar functionality.

It will be understood that when an element is referred to as being “connected” or “coupled” to another element, the elements may be directly connected or coupled via one or more inter-vening elements. If two elements A and B are combined using an “or”, this is to be understood to disclose all possible combinations, i.e. only A, only B as well as A and B, if not explicitly or implicitly defined otherwise. An alternative wording for the same combinations is “at least one of A and B” or “A and/or B”. The same applies, mutatis mutandis, for combinations of more than two Elements.

The terminology used herein for the purpose of describing particular examples is not intended to be limiting for further examples. Whenever a singular form such as “a,” “an” and “the” is used and using only a single element is neither explicitly or implicitly defined as being man-datory, further examples may also use plural elements to implement the same functionality. Likewise, when a functionality is subsequently described as being implemented using multiple elements, further examples may implement the same functionality using a single element or processing entity. It will be further understood that the terms “comprises,” “comprising,” “includes” and/or “including,” when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong.

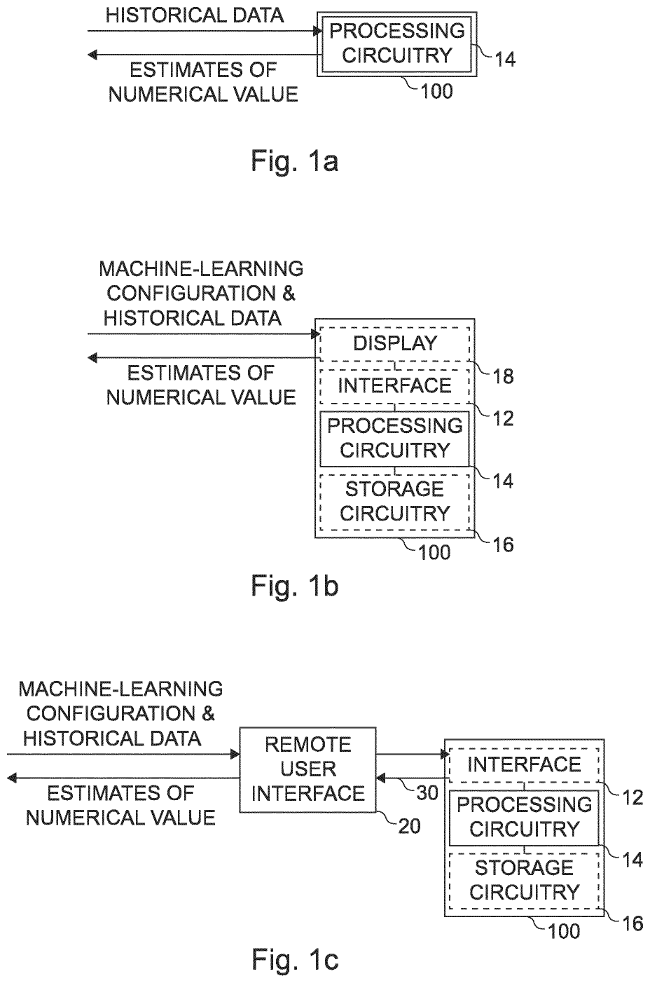

FIGS. 1a to 1c show block diagrams of embodiments of a system 100 for forecasting a trend of a numerical value over a time interval. The system comprising processing circuitry 14. In some embodiments, as shown in FIGS. 1b and 1c, the system may further comprise an interface 12 and/or storage circuitry 16. In general, the functionality of the system may be provided by the processing circuitry 14, e.g. in conjunction with the interface 12 and/or the storage circuitry 16. For example, the processing circuitry may be configured to provide a user interface via the interface 12, and/or to obtain historical data, a machine-learning configuration and/or a user evaluation via the interface 12. The processing circuitry 14 may be configured to use the storage circuitry to store information, e.g. the historical data, the machine-learning configuration, and/or one or more trained machine-learning models.

The processing circuitry is configured to determine an estimate of the numerical value for the time interval by training a first machine-learning model based on historical data on the numerical value. The processing circuitry is configured to divide the time interval into a first and a second sub-interval. The processing circuitry is configured to determine an estimate of the numerical value for the first sub-interval by training a second machine-learning model based on the historical data on the numerical value. The processing circuitry is configured to determine an estimate of the numerical value for the second sub-interval based on the estimate of the numerical value for the time interval and based on the estimate of the numerical value for the first sub-interval.

Embodiments of the present disclosure relate to a system, a method and a computer program for forecasting a trend of a numerical value over a time interval. In general, a trend of a numerical value shows the development of the numerical value over the time interval. For example, the numerical value may relate to a demand for a product. In this case, the trend of the numerical value may show how the demand for the product develops over time. Alternatively, the numerical value may relate to other fields. For example, the numerical value may represent a utilization of a vehicle, a utilization of a road, a suitable time for charging a vehicle, a suitable time for maintenance of a machine, or an amount of energy required for operating a machine etc. As the actual development of the numerical value of interest, the “trend” over the time interval might not relate to a single numerical value (e.g. a compound or accumulated numerical value) that covers the entire time interval. Instead, the trend may relate to a plurality of numerical values that each cover a sub-interval of the time interval (and which show the development of the numerical value across the sub-interval). Coming back to the “product demand” example, the trend of the numerical value may relate to a plurality of numerical values covering individual months (or even weeks) of the time interval.

As the numerical value is estimated for different time intervals, in the following, the terminology is introduced in more detail. For example, the “numerical value for the time interval” relates to an aggregate value that represents the entire time interval as a single numerical value. For example, in terms of product demand, the numerical value for the time interval may be the product demand over the entire time interval, as a single numerical value. Accordingly, the “numerical value for a sub-interval” (e.g. for the first or second sub-interval) relates to an aggregate value that represents the respective sub-interval as a single numerical value. For example, the product demand may be forecast over four months. In this case, the time interval may cover the four months, and the first and second sub-intervals may each cover two months, months one and two, and months three and four. In this case, the numerical value for the time interval relates to an aggregate value that represents the entire four months (e.g. 800 units of a product), the numerical value for the first sub-interval relates to an aggregate value that covers months one and two (e.g. 300 units of the product), and the numerical value for the second sub-interval relates to an aggregate value that covers months three and four (e.g. 500 units of the product). In various embodiments, the numerical value for the time interval may be the sum of the numerical values for the sub-intervals of the time intervals.

In some embodiments, the time interval may be divided even further, e.g. by further sub-dividing the sub-intervals. For example, the first or second sub-interval may (each) be divided into two further sub-intervals. Coming back to the previous example, the first sub-interval of the first sub-interval may cover the first month, the second sub-interval of the first sub-interval may cover the second month, the first sub-interval of the second sub-interval may cover the third month, and the second sub-interval of the second sub-interval may cover the fourth month. Accordingly, the numerical value for the first sub-interval of the first sub-interval relates to an aggregate value that covers month one etc. Further sub-divisions are possible, e.g. into weeks. Also, the sub-intervals may be of the same or of different length.

As has been pointed out before, the time interval is divided into the first and second sub-interval, which may again be sub-divided into further sub-intervals. In other words, the stretch of time defined by the time interval may be divided into further stretches of time (the sub-intervals of the time interval), which in aggregate form the time interval. In other words, the time interval may be a combination of the two sub-intervals of the time interval. In some embodiments, however, the time-interval may be divided into three sub-intervals. In this case, the same logic may be applied, with the three sub-intervals being combined to form the time interval. In this case, however, two machine-learning models may be trained to estimate the numerical values of two of the three sub-intervals.

In general, the (respective) second sub-interval may chronologically follow the (respective) first sub-interval. As the first sub-interval is usually closer to the historical data, its estimate may be more precise. Alternatively, however, the (respective) second sub-interval may chronologically precede the (respective) first sub-interval, e.g. if the machine-learning-based estimate for the later sub-interval promises to be more precise (e.g. due to less volatility in the sub-interval). In various embodiments, the first and second sub-interval may be of equal length (e.g. two months each, or one month each). Alternatively, the first and second sub-interval may be of different length (e.g. two months and one month, in case a quarter is sub-divided into months, with the two-month sub-period being further sub-divided into single months).

The processing circuitry is configured to determine the estimate of the numerical value for the time interval by training the first machine-learning model based on historical data on the numerical value. Accordingly, the processing circuitry is configured to determine the estimate of the numerical value for the first sub-interval by training the second machine-learning model based on the historical data on the numerical value. In other words, the estimate for the time interval and for the first sub-interval are determined using machine-learning.

Machine learning refers to algorithms and statistical models that computer systems may use to perform a specific task without using explicit instructions, instead relying on models and inference. For example, in machine-learning, instead of a rule-based transformation of data, a transformation of data may be used, that is inferred from an analysis of historical and/or training data. For example, the content of images may be analyzed using a machine-learning model or using a machine-learning algorithm. In order for the machine-learning model to analyze the content of an image, the machine-learning model may be trained using training images as input and training content information as output. By training the machine-learning model with a large number of training images and associated training content information, the machine-learning model “learns” to recognize the content of the images, so the content of images that are not included of the training images can be recognized using the machine-learning model. The same principle may be used for other kinds of data, such as numerical values, as well: By training a machine-learning model using training historical data and a desired output numerical value, the machine-learning model “learns” a transformation between the historical data and the output numerical value, which can be used to provide an output numerical value based on non-training historical data provided to the machine-learning model.

Machine-learning models are trained using training input data. The examples specified above use a training method called “supervised learning”. In supervised learning, the machine-learning model is trained using a plurality of training samples, wherein each sample may comprise a plurality of input data values, and a plurality of desired output values, i.e. each training sample is associated with a desired output value. By specifying both training samples and desired output values, the machine-learning model “learns” which output value to provide based on an input sample that is similar to the samples provided during the training. Supervised learning may be based on a supervised learning algorithm, e.g. a classification algorithm, a regression algorithm or a similarity learning algorithm. Regression algorithms may be used when the outputs may have any numerical value (within a range).

In embodiments, the first and second machine-learning models are trained based on the historical data on the numerical value, e.g. using supervised learning and a regression algorithm. A regression algorithm may be used, as an estimate of a numerical value is to be determined based on the historical data. For example, linear regression, Support Vector Regression (SVR), or regression trees may be used as regression algorithms. Supervised learning may be used, as supervised learning is a technique that enables deriving a result from data that is similar to the data that the machine-learning model is being trained on, in this case the historical data. In the present case, the historical data may both be used to train the machine-learning model, and to determine the estimates, albeit over different subsets of the historical data.

In general, the historical data may be similar (e.g. at least in a similar granularity) as the estimates that are to be generated, or can at least be aggregated to provide a similar granularity. For example, the historical data on the numerical value may comprise information on a trend/development of the numerical value over a previous time-interval (e.g. a previous year). For example, if the goal is to determine estimates for single months (or single weeks), the historical data may comprise information on a trend/development of the numerical value over the previous time-interval, by month (or at least summable by month), or by week (or at least summable by week). For example, the historical data may relate to historical demand for the product, e.g. by month or by week (or at last summable by month or by week).

Now, subsets of the historical data may be used to recreate the scenario faced by the estimate. For example, if the time interval spans four months, two subsets of the historical data may be used—a first subset (which may cover a span of time that is later available for performing the estimation), and a second subset, which may cover the same span of time that the time interval or sub-interval covers that is to be estimated. The second subset of the historical data may be aggregated and used as the desired/training output, and the first subset of the historical data may be used as training input. In other words, the respective machine-learning model may be trained by determining a first subset of the historical data and a second subset of the historical data. The second subset of the historical data may represent a length of time that is equal to the time interval the respective machine-learning model is being trained for. The first subset may generally represent any length of time (but might not include the first subset), but may preferably represent the same length of time that is later used to determine the estimate. Also, the first subset may be chosen such that it takes into account the time span between the historical data being used to determine the estimate and the time-interval/sub-interval that the estimate is being determined for. For example, if the estimate for the third month of the time-interval is to be determined (and the historical data is available up to the month before the time interval), then a two-month gap between the second subset of the historical data and the first subset of the historical data may be kept. The respective machine-learning model may be trained using the first subset of the historical data as training input and the second subset as training output for the training of the respective machine-learning model.

After the respective machine-learning model is trained, it may be used to determine the estimate of the respective time-interval or sub-interval. For example, at least a subset of the historical data may be used as input to the respective trained machine-learning model (e.g. the first or second machine-learning model), and the output of the respective trained machine-learning model may be used as estimate for the respective numerical value (or a value derived thereof). For example, the processing circuitry may be configured to determine the estimate of the numerical value for the time interval by using at least a subset of the historical data as input for the first machine-learning model, and using the output of the first machine-learning model as estimate (or a value derived thereof). Accordingly, the processing circuitry may be configured to determine the estimate of the numerical value for the first sub-interval by using at least a subset of the historical data as input for the second machine-learning model, and using the output of the second machine-learning model as estimate (or a value derived thereof).

Machine-learning algorithms are usually based on a machine-learning model. In other words, the term “machine-learning algorithm” may denote a set of instructions that may be used to create, train or use a machine-learning model. The term “machine-learning model” may denote a data structure and/or set of rules that represents the learned knowledge, e.g. based on the training performed by the machine-learning algorithm. In embodiments, the usage of a machine-learning model may imply that the machine-learning model and/or the data struc-ture/set of rules that is the machine-learning model is trained by a machine-learning algorithm.

For example, the machine-learning models may be trained based on a machine-learning configuration, the machine-learning configuration specifying a machine-learning algorithm and one or more parameters of the machine-learning algorithm. This machine-learning configuration may be changed by a user of the system, e.g. in order to find a configuration that produces a better (i.e. more precise/dependable result).

Contrary to the time-interval and the first sub-interval, the estimate of the numerical value for the second sub-interval is determined based on two other estimates, i.e. based on the estimate of the numerical value for the time interval and based on the estimate of the numerical value for the first sub-interval. In other words, the estimate of the numerical value for the second sub-interval is derived from the estimate of the numerical value for the time interval and from the estimate of the numerical value for the first sub-interval. For example, the estimate of the numerical value may be subtracted from the estimate for the time-interval (as the two sub-intervals yield the time-interval as combined). In other words, the processing circuitry may be configured to determine the estimate of the numerical value for the second sub-interval by subtracting the estimate of the numerical value for the first sub-interval from the estimate of the numerical value for the time interval. This also means that the determination of the estimate of the numerical value for the second sub-interval might not require the training of an additional machine-learning model, thus speeding up the process. In other words, the estimate of the numerical value for the respective second sub-interval may be determined without training a machine-learning model.

As has been pointed out before, each of the sub-intervals may be divided into further sub-intervals. Keeping in line with the presented approach, the estimate of the numerical values for the further sub-intervals may be determined by training a machine-learning model for one of the further sub-intervals, and deriving the estimate of the numerical value for the other of the further sub-intervals based on two estimates. In effect, the determination of the estimates may be performed in a recursive manner by further dividing the sub-intervals. In other words, the processing circuitry may be configured to determine estimates of the numerical value for sub-intervals of the first or second sub-interval by dividing the respective sub-interval into two further sub-intervals, determining the estimate of the numerical value for a first of the further sub-intervals by training a machine-learning model based on the historical data, and determining the estimate of the numerical value of a second of the further sub-intervals based on the estimate of the numerical value for the first further sub-interval and based on the estimate of the numerical value for the respective sub-interval being divided into the two further sub-intervals. For example, the sub-interval covering months one and two may be divided into a first further sub-interval for month one, and a second further sub-interval for month two. The estimate of the numerical value for month one may be determined by training a machine-learning model (and then using the machine-learning model to determine the estimate), and the estimate of the numerical value for month two may be determined by subtracting the estimate of the numerical value for month one from the of the numerical value for months one and two.

As has been pointed out before, a possible benefit of the above approach is the fast generation of a rough estimate, which may be used by a user of the system to evaluate the estimates being determined. If the determined estimates seem off, the user may alter/update the machine-learning configuration, and retry determining the estimates based on the altered/updated ma-chine-learning configuration.

The basis of the evaluation is the presentation of at least one of the estimates (i.e. the estimate for the time-interval, which may be determined first) to the user. In other words, the processing circuitry may be configured to provide information on at least one of the estimates to a user via a user interface 18; 20 (see FIGS. 1b and/or 1c). For example, the at least one estimate may be shown as soon as it/they are determined. For example, the first and second machine-learning models may be trained sequentially, i.e. the second machine-learning model may be trained after the training of the first machine-learning model is completed. The same applies to the machine-learning model or models trained for the further sub-intervals. To sum it up, the machine-learning models might not be trained at the same time, but one after another. At the same time, the estimate or estimates of the numerical that are being determined based on the trained machine-learning models may be provided to the user via the user interface as soon as they are available.

For example, in general, the processing performed by the processing circuitry may be performed by a central processing unit (CPU), which is a general-purpose processors that may be used both for executing an operating system of the system and application programs, such as an application program for determining the estimates. In many cases however, the machine-learning models are trained using an additional processing facility, such as one or more general purpose graphics processing units (GP-GPUs). Accordingly, the processing circuitry may comprise such an additional processing facility, e.g. a GP-GPU. The determination of the estimates based on the trained machine-learning models, however, might be determined by the CPU. Thus, once the training of a machine-learning model is completed, the corresponding estimate of the numerical value may be determined by the CPU, and the GPU may be used to train the subsequent machine-learning model. As the usage of a machine-learning model is usually far less computationally intensive (e.g. taking seconds or fractions of seconds vs. minutes or more), the respective estimate of the numerical value may be provided to the user while the subsequent machine-learning model is being trained, thus reducing a time the user has to wait to get preliminary results. In other words, the user may get presented partial results before the completed results are available. The same holds true estimates being determined for successively smaller and smaller sub-intervals. Accordingly, progressively finer estimates may be provided to the user via the user interface as they come (as opposed to all at once).

In more general terms, the processing circuitry may be configured to provide the estimate of the numerical value for the time interval to the user before starting or before completing the determination of the estimate of the numerical value for the first sub-interval. For example, the processing circuitry may be configured to provide the estimate of the numerical value to the user while the second machine-learning model is being trained. Accordingly, the processing circuitry may be configured to provide the estimate of the numerical value for a sub-interval to the user before starting or before completing the determination of the estimate of the numerical value for a further sub-interval of the sub-interval, e.g. while a machine-learning model is being trained for a further sub-interval of the sub-interval. For example, in general, the estimate of the numerical value for a time interval or sub-interval may be provided before the determination of the estimates of the numerical value for sub-intervals of the time interval or of the sub-interval is completed.

The estimate or estimates may be provided to the user to enable the user to quickly ascertain whether the chosen machine-learning configuration is suitable, enabling the user to cancel the determination of the estimation, update the machine-learning configuration, and repeat the determination of the estimates with the updated machine-learning configuration. Accordingly, the processing circuitry may be configured to adapt the machine-learning configuration based on an evaluation of at least one of the estimates. In some embodiments, the system itself may evaluate the at least one estimate, and adapt the machine-learning configuration if the at least one estimate is obviously off. In various embodiments, however, the evaluation may be performed by a user, i.e. based on an input by the user, via the user interface. In other words, the processing circuitry may be configured to adapt the machine-learning configuration based on a user evaluation of at least one of the estimates.

For example, the user evaluation may be performed via the user interface. In other words, the processing circuitry may be configured to evaluate at least one of the estimates by providing information on at least one of the estimates (e.g. sequentially, as soon as the respective estimate is determined) to a user via the user interface 18; 20, and by obtaining information on the evaluation of the at least one estimate from the user via the user interface. For example, the information on the evaluation of the at least one estimate may comprise a command to cancel the determination of the estimates, and to restart the determination of the estimates with an updated machine-learning configuration. In other words, when presented with the at least one estimate, the user may be given the choice to abort the process and adapt the (i.e. choose a different) machine learning configuration. Accordingly, the information on the evaluation may comprise information on the updated machine-learning model. For example, the processing circuitry may be configured to adapt the machine-learning configuration based on the information on the information on the evaluation. The system may be configured to abort the determination of the estimates that is based on the initially used machine-learning configuration after adapting the machine-learning configuration, and to repeat the determination of the estimates using the adapted machine-learning configuration (e.g. as a result of the evaluation of the at least one estimate).

As has been pointed out before, the user may control the process via the user interface. In particular, the user may start and/or cancel the determination of the determination of the estimates via the interface, adjust the machine-learning configuration, and/or set the time interval and sub-intervals via the user interface. In other words, the processing circuitry may be configured to obtain at least one of information on the time interval, information on the first and second sub-interval, and information on a machine-learning configuration from a user via a user interface. In particular, the user may select a machine-learning algorithm and one or more parameters of the machine-learning algorithm via the user interface (as parts of the machine-learning configuration. In other words, the user may choose a machine learning configuration (algorithm+parameters), e.g. before starting the determination of the estimates, or as part of an evaluation of the at least one estimate. Additionally, the processing circuitry may be configured to the obtain the historical data via the user interface. For example, the user may up-load or input the historical data. Alternatively, the historical data may already be present, e.g. stored in storage circuitry of the system.

In FIGS. 1b and 1c, schematic diagrams of embodiments of the system are shown, in which different means are used to provide the user interface to the user. For example, in FIG. 1b, a schematic diagram of an embodiment of the system is shown, in which the system comprises a display 18, which is coupled to the processing circuitry 14 via the interface 12. The display may be used to provide the user interface for the user. For example, the processing circuitry may be configured to provide the information on the at least one estimate via a user interface being shown on the display 18. Additionally, the processing circuitry may be configured to obtain information from the user via the user interface. For example, the processing circuitry may be configured to obtain at least one of information on the time interval, information on the first and second sub-interval, information on a machine-learning configuration, and the information on the evaluation from the user via the user interface. For example, the user interface may be a graphical user interface, and the user may input the information on the time interval, the information on the first and second sub-interval, he information on the evaluation from the user and/or the information on a machine-learning configuration via the user interface, e.g. by inputting or selecting them in the user interface. For example, the display may be a touch screen display for obtaining the user input, or the user input may be obtained via a keyboard, mouse or touchpad being coupled with the processing circuitry (e.g. via the interface). For example, the display may be a Liquid Crystal Display or an Organic Light Emitting Diode-based display.

Alternatively, the user interface may be a remote user interface, i.e. a user interface being presented by a remote computing device, e.g. via a web browser or via an application program. In other words, the processing circuitry may be configured to provide the information on the at least one estimate to a remote user interface 20 via a computer network 30. For example, in FIG. 1c, a schematic diagram of an embodiment of the system is shown, in which the processing circuitry is coupled to a remote user interface 20 via a computer network 30, e.g. via the interface 12. For example, the remote user interface may be implemented by a web browser or application program. The processing circuitry may be configured to exchange information with the remote user interface via the computer network, e.g. via the internet or via an intranet. For example, the processing circuitry may be configured to obtain at least one of the information on the time interval, the information on the first and second sub-interval, he information on the evaluation from the user and the information on a machine-learning configuration from the user via the remote user interface. For example, the user may input the respective information into a form (or select it from a form) shown by the remote user interface.

In general, embodiments relate to machine-learning and machine-learning models. For example, the machine-learning model (e.g. the first and/or second machine-learning model) may be an artificial neural network (ANN). ANNs are systems that are inspired by biological neural networks, such as can be found in a brain. ANNs comprise a plurality of interconnected nodes and a plurality of connections, so-called edges, between the nodes. There are usually three types of nodes, input nodes that receiving input values, hidden nodes that are (only) connected to other nodes, and output nodes that provide output values. Each node may represent an artificial neuron. Each edge may transmit information, from one node to another. The output of a node may be defined as a (non-linear) function of the sum of its inputs. The inputs of a node may be used in the function based on a “weight” of the edge or of the node that provides the input. The weight of nodes and/or of edges may be adjusted in the learning process. In other words, the training of an artificial neural network may comprise adjusting the weights of the nodes and/or edges of the artificial neural network, i.e. to achieve a desired output for a given input. In at least some embodiments, the machine-learning model may be deep neural network, e.g. a neural network comprising one or more layers of hidden nodes (i.e. hidden layers), prefer-ably a plurality of layers of hidden nodes.

Alternatively, the first or second machine-learning model (or the further machine-learning model) may be a support vector machine. Support vector machines (i.e. support vector networks) are supervised learning models with associated learning algorithms that may be used to analyze data, e.g. in classification or regression analysis. Support vector machines may be trained by providing an input with a plurality of training input values that belong to one of two categories. The support vector machine may be trained to assign a new input value to one of the two categories. Alternatively, the machine-learning model may be a Bayesian network, which is a probabilistic directed acyclic graphical model. A Bayesian network may represent a set of random variables and their conditional dependencies using a directed acyclic graph. Alternatively, the machine-learning model may be based on a genetic algorithm, which is a search algorithm and heuristic technique that mimics the process of natural selection.

In embodiments the processing circuitry 14 may be implemented using one or more processing units, one or more processing devices, any means for processing, such as a processor, a computer or a programmable hardware component being operable with accordingly adapted software. In other words, the described function of the processing circuitry 14 may as well be implemented in software, which is then executed on one or more programmable hardware components. Such hardware components may comprise a general purpose processor, a Digital Signal Processor (DSP), a micro-controller, etc.

The interface 12 may correspond to one or more inputs and/or outputs for receiving and/or transmitting information, which may be in digital (bit) values according to a specified code, within a module, between modules or between modules of different entities. For example, the interface 12 may comprise interface circuitry configured to receive and/or transmit information.

In at least some embodiments, the storage circuitry 16 may comprise at least one element of the group of a computer readable storage medium, such as an magnetic or optical storage medium, e.g. a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

For example, the system 100 may be a computer system. Alternatively, a computer system may comprise the system 100.

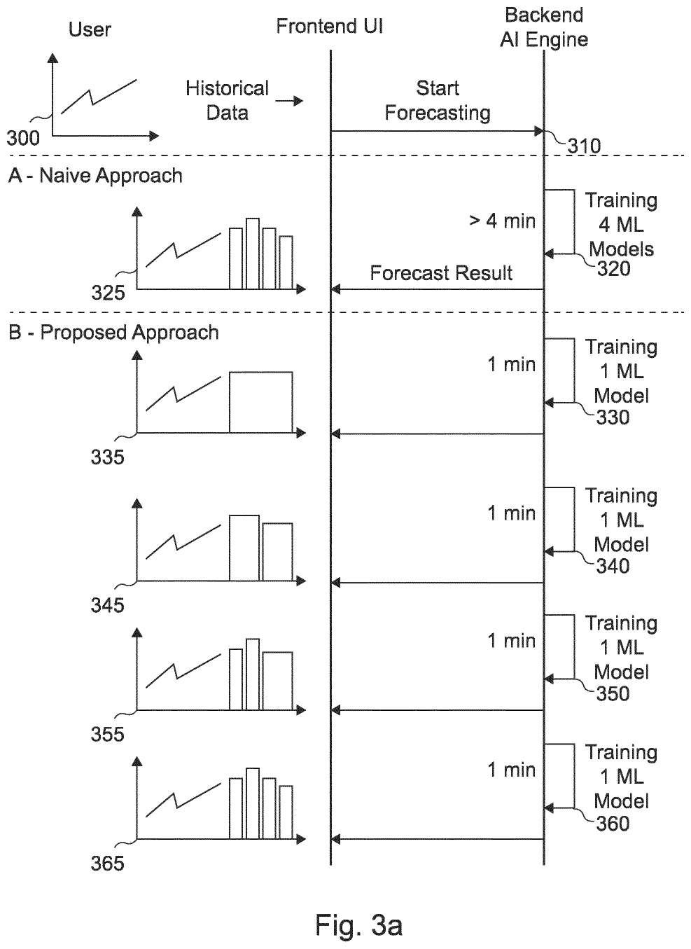

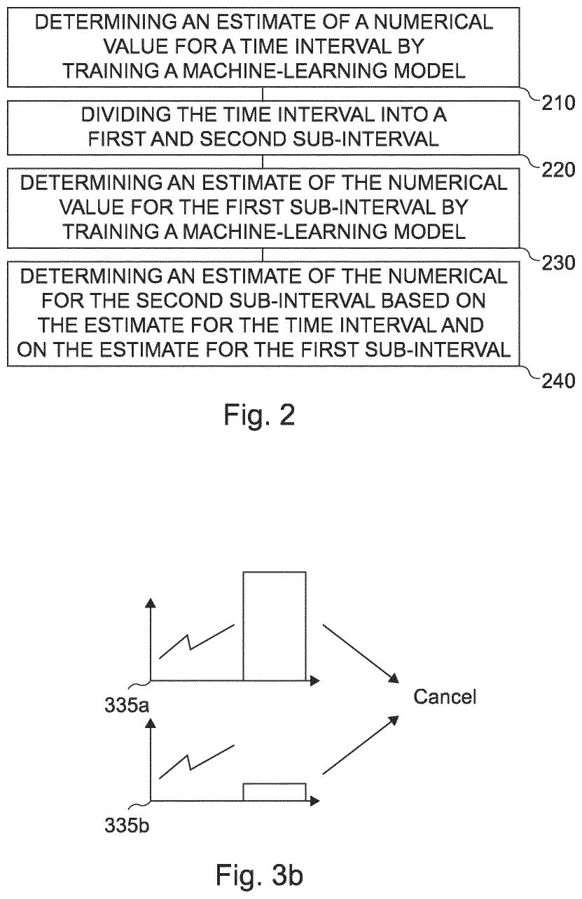

More details and aspects of the system are mentioned in connection with the proposed concept or one or more examples described above or below (e.g. FIGS. 2 to 3b). The system may comprise one or more additional optional features corresponding to one or more aspects of the proposed concept or one or more examples described above or below.

FIG. 2 shows a flow chart of a corresponding method for forecasting a trend of a numerical value over a time interval. The method comprises determining 210 an estimate of the numerical value for the time interval by training a first machine-learning model based on historical data on the numerical value. The method comprises dividing 220 the time interval into a first and a second sub-interval. The method comprises determining 230 an estimate of the numerical value for the first sub-interval by training a second machine-learning model based on the historical data on the numerical value. The method comprises determining 240 an estimate of the numerical value for the second sub-interval based on the estimate of the numerical value for the time interval and based on the estimate of the numerical value for the first sub-interval.

As has been indicated before, features described in connection with the system of FIGS. 1a to 1c may likewise be applied to the method of FIG. 2.

More details and aspects of the method are mentioned in connection with the proposed concept or one or more examples described above or below (e.g. FIG. 1a to 1c, 3a to 3b). The method may comprise one or more additional optional features corresponding to one or more aspects of the proposed concept or one or more examples described above or below.

At least some embodiments relate to progressive demand forecasting.

Businesses want to forecast product demand in order to optimize their supply chain. FIG. 3a shows a schematic diagram of two approaches for forecasting a trend of a numerical value, which may be used to forecast the product demand. In FIG. 3a, forecasting is shown for the next four months of demand.

Such forecasts can be determined in the following manner. In some approaches, an approach (denoted naïve approach “A” in FIG. 3a) may be taken, where the entire forecast is determined in the desired time-granularity, and subsequently presented to the user.

First, a user (e.g. an analyst) may load historical data 300, such as historical product demand data, into a system, e.g. through its frontend user interface (UI). The user may also use the user interface to configure some forecasting parameters such as e.g. the length of the forecasting period unit, and the number of units (e.g. four periods of one month duration each), the forecasting method to use, and how to generate derived features from the input data.

The user interface may transfer 310 the data to some backend AI (Artificial Intelligence) en-gine that performs the necessary data processing (e.g. Machine Learning) to train a model 320 and produce a forecast 325. For example, for each of the future periods to forecast (e.g. for each of the four one-month periods in the example), a model may be trained that best fits the historical data, and the trained model may be executed on the latest historical data point(s) only, to predict the future data point. This may be repeated for each future period to forecast. After some processing delay, the forecast results may be returned to the user.

In other words, in case A, the processing step comprises training 4 different machine learning models, one each for month+1, month+2, month+3, and month+4. This is computationally intensive. In the example shown in FIG. 3a, each machine-learning training is assumed to take one minute (as an example), thus 4 minutes in total. The demand for the next four months is forecast individually by executing each of the four models.

Training a Machine Learning model typically requires testing different algorithms and parameters to find the configuration that produces the best model (i.e. the most accurate predic-tions when applied onto the historical data). An algorithm may be run with different values of some algorithm-specific configuration parameters (which may be different from the forecasting parameters, e.g. learning rate, regularization parameter, etc.). Furthermore, different Machine Learning algorithms may be evaluated.

This evaluation of different parameters or algorithms may be hindered by the Machine Learning training, which is potentially long and is executed for each of the forecasts periods before any results are returned at all. Thus, the processing delay may be long, during which the user has no feedback. The user may wait for that delay before they can assess the forecast and possibly decide to modify the forecasting parameters and run another forecast.

Another issue that may affect machine-learning based forecasting arises when the data has a lot of period-to-period variance. In this case, it may be difficult to train an accurate model, even for the historical data, because the variance means there is no clear pattern to be extracted by the model. In other words, it may be difficult to distinguish variance from random noise. Forecasting errors caused by the issue above may add up. For example, overestimating the monthly demand for each of the next 12 months may add up to a large overestimation of the demand for the next year.

In embodiments of the present disclosure, however, another approach may be chosen (denoted proposed approach “B”). In the proposed approach, the entire forecasting period (i.e. the time interval) may be predicted at once (i.e. the estimate for the time interval may be determine). For example, the training and prediction introduced in the following may be performed by the system of FIGS. 1a to 1c. For example, in FIG. 3a, demand may be forecast for the next 4 months as one block. For example, this may be performed first. A corresponding machine-learning model may be trained 330, and a forecast 335 may be determined.

Subsequently, the demand may be forecast for the next 2 months (i.e. the first sub-interval) as one block. A corresponding machine-learning model may be trained 340, and a forecast 345 may be determined. The demand for months 3 and 4 may be deduced (i.e. the estimate for the second sub-interval may be determined), by subtracting the above forecasts from each other.

The forecast may be recursively defined by following the same procedure above. For example, to predict the forecast on a monthly basis, a machine-learning model may be trained 350 for predicting the forecast 355 of the demand for the first month, and the demand for the second month may be deduced based on the demand forecast for the first two months and the demand forecast for the first month. Accordingly, a machine-learning model may be trained 360 for predicting the forecast 365 of the demand for the third month, and the demand for the fourth month may be deduced based on the demand forecast for months three and four and the demand forecast for the third month.

In other words, first, the demand may be forecast for the entire four months as one block, at once. As only one model is trained 330, this takes only one minute. The demand may be forecast by executing that model. An intermediate (though coarse) forecast 335 may be returned to the user. Then, demand may be forecast for the next two months (months 1+2) as one block. Again, this may involve training 340 one model and take one minute. The demand for months 3+4 may be deduced, by subtracting the above forecasts from each other. Again, a refined (but still somewhat coarse) forecast 345 may be returned to the user. The forecast may be recursively refined by following the same procedure above.

Using this approach, the user may receive early (albeit not refined) results, and may decide that the forecast is not satisfactory, cancel the forecasting processing, and try another set of forecasting parameters. FIG. 3b shows schematic diagrams of exemplary forecasts 335a, 335b for the entire time period/time interval. If the forecasts seem to be implausible relative to the historical data, as shown in FIG. 3b, the user may decide that the forecast is not satisfactory, cancel the forecasting processing, and try another set of forecasting parameters.

In addition, additive forecasting errors may be avoided. For example, with reference to FIG. 3a, instead of potentially adding up 4 monthly forecast errors, the entire 4-month period is forecasted at once. Forecasting discontinuities may be avoided by the differential nature of intermediate forecast.

For example, due to high monthly variance in the historical data, it may be difficult to extract a clear pattern and train a stable and accurate model. In turn this may lead to, for instance, overestimating the monthly demand for each of the next 12 months. Together, these individual monthly overestimations may add up to a large overestimation of the demand for the next year.

In various embodiments, however, in a first step, all monthly values in the historical data may be replaced with the sum over the previous (twelve in the example above) months of data. This may reduce the month-to-month variance and help to train a more accurate (twelve-month) model. For example:

Month M may be replaced by Σ(M-11, M-10, M-9 . . . M)

Month M+1 may replaced by Σ(M-10, M-9 . . . M, M+1)

Month M+2 may replaced by Σ(M-9 . . . M, M+1, M+2)

In this example, two consecutive replacement values have 10 out 12 terms of the sum in com-mon. This may reduce (relative) variance between consecutive values. Out of this summed data, a model may be trained to predict the sum of values over a twelve-month period.

Moreover, since values are forecast for (future) small periods by subtracting forecasts for other small periods from the larger (twelve-month) period, it may be ensured that the monthly forecasts correctly add up.

For example, in an exemplary formal definition, if one assumes that today is N, next month (the first month to forecast) is N+1 and the following months are N+2, N+3, etc., the forecast may be defined as follows:

forecast([N+1 to N+4]):=model([N+1 to N+4]):

In other words, the forecast for months N+1 to N+4 is obtained by training a (single) model for months N+1 to N+4.

forecast([N+1 to N+2]):=model([N+1 to N+2]): The forecast for months N+1 to N+2 is obtained by training a (single) model for months N+1 to N+2.

forecast([N+3 to N+4]):=forecast([N+1 to N+4])— forecast([N+1 to N+2]) The forecast for months N+3 to N+4 is obtained by subtracting the forecast for months N+1 and N+2 from the forecast for months N+1 to N+4.

The same may be recursively performed for the individual months.

forecast(N+1):=model(N+1): The forecast for month N+1 is obtained by training a (single) model for month N+1.

forecast(N+2):=forecast([N+1 to N+2])— forecast(N+1): The forecast for month N+2 is obtained by subtracting the forecast for month N+1 from the forecast for months N+1 and N+2.

forecast(N+3):=model(N+3): The forecast for month N+3 is obtained by training a (single) model for month N+3.

forecast(N+4):=forecast([N+3 to N+4))−forecast(N+3):

The forecast for month N+4 is obtained by subtracting the forecast for month N+3 from the forecast for months N+3 and N+4.

Consequently, forecasting discontinuities may be avoided by the differential nature of intermediate forecasts. As can be seen from the example, in some embodiments, two consecutive short-period values might never be forecast from short-period models, which can have a high variance. Instead, the first value may be forecast from a short-period model (but nearer in the future). The second value may be forecast by subtracting the first value from a longer-period model (which therefore should have less variance).

More details and aspects of the concept are mentioned in connection with the proposed concept or one or more examples described above or below (e.g. FIG. 1a to 2). The concept may comprise one or more additional optional features corresponding to one or more aspects of the proposed concept or one or more examples described above or below.

The following examples pertain to further embodiments:
(1) A system 100 for forecasting a trend of a numerical value over a time interval, the system comprising processing circuitry 14 configured to:
determine an estimate of the numerical value for the time interval by training a first machine-learning model based on historical data on the numerical value;
divide the time interval into a first and a second sub-interval;
determine an estimate of the numerical value for the first sub-interval by training a second machine-learning model based on the historical data on the numerical value; and determine an estimate of the numerical value for the second sub-interval based on the estimate of the numerical value for the time interval and based on the estimate of the numerical value for the first sub-interval.
(2) The system according to (1), wherein the processing circuitry is configured to determine the estimate of the numerical value for the second sub-interval by subtracting the estimate of the numerical value for the first sub-interval from the estimate of the numerical value for the time interval.
(3) The system according to one of (1) or (2), wherein the processing circuitry is configured to determine estimates of the numerical value for sub-intervals of the first or second sub-interval by dividing the respective sub-interval into two further sub-intervals, determining the estimate of the numerical value for a first of the further sub-intervals by training a machine-learning model based on the historical data, and determining the estimate of the numerical value of a second of the further sub-intervals based on the estimate of the numerical value for the first further sub-interval and based on the estimate of the numerical value for the respective sub-interval being divided into the two further sub-intervals.
(4) The system according to one of (1) to (3), wherein the estimate of the numerical value for the respective second sub-interval is determined without training a machine-learning model.
(5) The system according to one of (1) to (4), wherein the machine-learning models are trained based on a machine-learning configuration, the machine-learning configuration specifying a machine-learning algorithm and one or more parameters of the ma-chine-learning algorithm, the processing circuitry being configured to adapt the ma-chine-learning configuration based on an evaluation of at least one of the estimates.
(6) The system according to (5), wherein the processing circuitry is configured to adapt the machine-learning configuration based on a user evaluation of at least one of the estimates.
(7) The system according to one of (5) or (6), wherein the processing circuitry is configured to evaluate at least one of the estimates by providing information on at least one of the estimates to a user via a user interface (18; 20), and by obtaining information on the evaluation of the at least one estimate from the user via the user interface.
(8) The system according to one of (5) to (7), wherein the system is configured to abort the determination of the estimates that is based on the initially used machine-learning configuration after adapting the machine-learning configuration, and to repeat the determination of the estimates using the adapted machine-learning configuration.
(9) The system according to one of (1) to (8), wherein the respective machine-learning model is trained by determining a first subset of the historical data and a second subset of the historical data, the second subset of the historical data representing a length of time that is equal to the time interval the respective machine-learning model is being trained for, and using the first subset of the historical data as training input and the second subset as training output for the training of the respective machine-learning model.
(10) The system according to one of (1) to (9), wherein the second sub-interval chronologically follows the first sub-interval.
(11) The system according to one of (1) to (10), wherein the first and second sub-interval are of equal length.
(12) The system according to one of (1) to (10), wherein the first and second sub-interval are of different length.
(13) The system according to one of (1) to (12), wherein the processing circuitry is configured to provide information on at least one of the estimates to a user via a user interface 18; 20.
(14) The system according to (13), wherein the system comprises a display 18, the processing circuitry being configured to provide the information on the at least one estimate via a user interface being shown on the display.
(15) The system according to (13), wherein the processing circuitry is configured to provide the information on the at least one estimate to a remote user interface 20 via a computer network 30.
(16) The system according to one of (13) to (15), wherein the processing circuitry is configured to provide the estimate of the numerical value for the time interval to the user before starting or before completing the determination of the estimate of the numerical value for the first sub-interval.
(17) The system according to one of (13) to (16), wherein the estimate of the numerical value for a time interval or sub-interval is provided before the determination of the estimates of the numerical value for sub-intervals of the time interval or of the sub-interval is completed.
(18) The system according to one of (1) to (17), wherein the processing circuitry is configured to obtain at least one of information on the time interval, information on the first and second sub-interval, and information on a machine-learning configuration from a user via a user interface.
(19) The system according to one of (1) to (18), wherein the numerical value relates to a demand for a product, the historical data relating to historical demand for the product.
(20) A method for estimating a trend of a numerical value over a time interval, the method comprising:
determining 210 an estimate of the numerical value for the time interval by training a first machine-learning model based on historical data on the numerical value;
dividing 220 the time interval into a first and a second sub-interval;
determining 230 an estimate of the numerical value for the first sub-interval by training a second machine-learning model based on the historical data on the numerical value; and determining 240 an estimate of the numerical value for the second sub-interval based on the estimate of the numerical value for the time interval and based on the estimate of the numerical value for the first sub-interval.
(21) A computer program having a program code for performing the method of (20), when the computer program is executed on a computer, a processor, or a programmable hardware component.

The aspects and features mentioned and described together with one or more of the previously detailed examples and figures, may as well be combined with one or more of the other examples in order to replace a like feature of the other example or in order to additionally introduce the feature to the other example.

Examples may further be or relate to a computer program having a program code for performing one or more of the above methods, when the computer program is executed on a computer or processor. Steps, operations or processes of various above-described methods may be performed by programmed computers or processors. Examples may also cover program storage devices such as digital data storage media, which are machine, processor or computer readable and encode machine-executable, processor-executable or computer-executable programs of instructions. The instructions perform or cause performing some or all of the acts of the above-described methods. The program storage devices may comprise or be, for instance, digital memories, magnetic storage media such as magnetic disks and magnetic tapes, hard drives, or optically readable digital data storage media. Further examples may also cover computers, processors or control units programmed to perform the acts of the above-described methods or (field) programmable logic arrays ((F)PLAs) or (field) programmable gate arrays ((F)PGAs), programmed to perform the acts of the above-described methods.

The description and drawings merely illustrate the principles of the disclosure. Furthermore, all examples recited herein are principally intended expressly to be only for illustrative pur-poses to aid the reader in understanding the principles of the disclosure and the concepts con-tributed by the inventor(s) to furthering the art. All statements herein reciting principles, aspects, and examples of the disclosure, as well as specific examples thereof, are intended to encompass equivalents thereof.

A functional block denoted as “means for . . . ” performing a certain function may refer to a circuit that is configured to perform a certain function. Hence, a “means for s.th.” may be implemented as a “means configured to or suited for s.th.”, such as a device or a circuit configured to or suited for the respective task.

Functions of various elements shown in the figures, including any functional blocks labeled as “means”, “means for providing a signal”, “means for generating a signal.”, etc., may be implemented in the form of dedicated hardware, such as “a signal provider”, “a signal processing unit”, “a processor”, “a controller”, etc. as well as hardware capable of executing software in association with appropriate software. When provided by a processor, the functions may be provided by a single dedicated processor, by a single shared processor, or by a plurality of individual processors, some of which or all of which may be shared. However, the term “processor” or “controller” is by far not limited to hardware exclusively capable of executing software, but may include digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

A block diagram may, for instance, illustrate a high-level circuit diagram implementing the principles of the disclosure. Similarly, a flow chart, a flow diagram, a state transition diagram, a pseudo code, and the like may represent various processes, operations or steps, which may, for instance, be substantially represented in computer readable medium and so executed by a computer or processor, whether or not such computer or processor is explicitly shown. Methods disclosed in the specification or in the claims may be implemented by a device having means for performing each of the respective acts of these methods.

It is to be understood that the disclosure of multiple acts, processes, operations, steps or functions disclosed in the specification or claims may not be construed as to be within the specific order, unless explicitly or implicitly stated otherwise, for instance for technical reasons.

Therefore, the disclosure of multiple acts or functions will not limit these to a particular order unless such acts or functions are not interchangeable for technical reasons. Furthermore, in some examples a single act, function, process, operation or step may include or may be broken into multiple sub—acts, -functions, -processes, -operations or—steps, respectively. Such sub acts may be included and part of the disclosure of this single act unless explicitly excluded.

Furthermore, the following claims are hereby incorporated into the detailed description, where each claim may stand on its own as a separate example. While each claim may stand on its own as a separate example, it is to be noted that—although a dependent claim may refer in the claims to a specific combination with one or more other claims—other examples may also include a combination of the dependent claim with the subject matter of each other dependent or independent claim. Such combinations are explicitly proposed herein unless it is stated that a specific combination is not intended. Furthermore, it is intended to include also features of a claim to any other independent claim even if this claim is not directly made dependent to the independent claim.

What is claimed is:

1. A system for forecasting a trend of a numerical value over a time interval, the system comprising processing circuitry configured to:
determine an estimate of the numerical value for the time interval by training a first machine-learning model based on historical data on the numerical value;
divide the time interval into a first and a second sub-interval;
determine an estimate of the numerical value for the first sub-interval by training a second machine-learning model based on the historical data on the numerical value; and
determine an estimate of the numerical value for the second sub-interval based on the estimate of the numerical value for the time interval and based on the estimate of the numerical value for the first sub-interval.

2. The system according to claim 1, wherein the processing circuitry is configured to determine the estimate of the numerical value for the second sub-interval by subtracting the estimate of the numerical value for the first sub-interval from the estimate of the numerical value for the time interval.

3. The system according to claim 1, wherein the processing circuitry is configured to determine estimates of the numerical value for sub-intervals of the first or second sub-interval by dividing the respective sub-interval into two further sub-intervals, determining the estimate of the numerical value for a first of the further sub-intervals by training a machine-learning model based on the historical data, and determining the estimate of the numerical value of a second of the further sub-intervals based on the estimate of the numerical value for the first further sub-interval and based on the estimate of the numerical value for the respective sub-interval being divided into the two further sub-intervals.

4. The system according to claim 1, wherein the estimate of the numerical value for the respective second sub-interval is determined without training a machine-learning model.

5. The system according to claim 1, wherein the machine-learning models are trained based on a machine-learning configuration, the machine-learning configuration specifying a machine-learning algorithm and one or more parameters of the machine-learning algorithm, the processing circuitry being configured to adapt the machine-learning configuration based on an evaluation of at least one of the estimates.

6. The system according to claim 5, wherein the processing circuitry is configured to adapt the machine-learning configuration based on a user evaluation of at least one of the estimates.

7. The system according to claim 5, wherein the processing circuitry is configured to evaluate at least one of the estimates by providing information on at least one of the estimates to a user via a user interface, and by obtaining information on the evaluation of the at least one estimate from the user via the user interface.

8. The system according to claim 5, wherein the system is configured to abort the determination of the estimates that is based on the initially used machine-learning configuration after adapting the machine-learning configuration, and to repeat the determination of the estimates using the adapted machine-learning configuration.

9. The system according to claim 1, wherein the respective machine-learning model is trained by determining a first subset of the historical data and a second subset of the historical data, the second subset of the historical data representing a length of time that is equal to the time interval the respective machine-learning model is being trained for, and using the first subset of the historical data as training input and the second subset as training output for the training of the respective machine-learning model.

10. The system according to claim 1, wherein the second sub-interval chronologically follows the first sub-interval.

11. The system according to claim 1, wherein the first and second sub-interval are of equal length.

12. The system according to claim 1, wherein the first and second sub-interval are of different length.

13. The system according to claim 1, wherein the processing circuitry is configured to provide information on at least one of the estimates to a user via a user interface.

14. The system according to claim 13, wherein the system comprises a display, the processing circuitry being configured to provide the information on the at least one estimate via a user interface being shown on the display.

15. The system according to claim 13, wherein the processing circuitry is configured to provide the information on the at least one estimate to a remote user interface via a computer network.

16. The system according to claim 13, wherein the processing circuitry is configured to provide the estimate of the numerical value for the time interval to the user before starting or before completing the determination of the estimate of the numerical value for the first sub-interval.

17. The system according to claim 13, wherein the estimate of the numerical value for a time interval or sub-interval is provided before the determination of the estimates of the numerical value for sub-intervals of the time interval or of the sub-interval is completed.

18. The system according to claim 1, wherein the processing circuitry is configured to obtain at least one of information on the time interval, information on the first and second sub-interval, and information on a machine-learning configuration from a user via a user interface.

19. A method for estimating a trend of a numerical value over a time interval, the method comprising:
determining an estimate of the numerical value for the time interval by training a first machine-learning model based on historical data on the numerical value;
dividing the time interval into a first and a second sub-interval;
determining an estimate of the numerical value for the first sub-interval by training a second machine-learning model based on the historical data on the numerical value; and
determining an estimate of the numerical value for the second sub-interval based on the estimate of the numerical value for the time interval and based on the estimate of the numerical value for the first sub-interval.

20. A computer program having a program code for performing the method of claim 19, when the computer program is executed on a computer, a processor, or a programmable hardware component.
